(19) United States
(12) Patent Application Publication
(10) Pub. No.: US 2015/0282912 A1
(43) Pub. Date: Oct. 8, 2015

(54) PLAQUE DETECTION USING A STREAM PROBE

(71) Applicant: KONINKLIJKE PHILIPS N.V., Eindhoven (NL)

(72) Inventors: Menno Willem Jose Prins, Rosmalen (NL); Johannes Hendrikus Maria Spruit, Waaalre (NL); Mark Thomas Johnson, Arendonk (BE); Okke Ouweltjes, Veldhoven (NL)

(21) Appl. No.: 14/443,538

(22) PCT Filed: Dec. 2, 2013
(86) PCT No.: PCT/IB2013/060551

§ 371 Date: May 18, 2015

Related U.S. Application Data
(60) Provisional application No. 61/740,904, filed on Dec. 21, 2012.

(51) Int. Cl. A61C 19/04

(52) U.S. Cl. CPC A61C 19/04

(57) ABSTRACT

An apparatus for detecting the presence of a substance on a surface includes a proximal pump portion and at least one distal probe portion configured to be immersed in a first fluid. The proximal pump portion and the distal probe portion are in fluid communication with one another. The distal probe portion defines a distal tip having an open port to enable the passage of a second fluid therethrough. The apparatus is configured such that passage of the second fluid through the distal tip enables detection of a substance that may be present on the surface based on measurement of a signal correlating to, in proximity to the surface, one or more bubbles generated by the second fluid in the first fluid. A corresponding method of detection includes probing the properties of an interaction zone via outflow of the second fluid medium from the surface.

### BACKGROUND

1. Technical Field

The present disclosure relates to apparatuses used for detecting the state of a dental surface. More particularly, the present disclosure relates to a stream probe that is utilized to detect the state of a dental surface.

2. Description of Related Art

Caries or periodontal diseases are thought to be infectious diseases caused by bacteria present in dental plaques. Removal of dental plaques is highly important for the health of oral cavities. Dental plaques, however, are not easy to identify by the naked eye. A variety of plaque detection apparatuses have been produced to aid in the detection of dental plaque and/or caries.

Most of the dental plaque detection apparatuses are configured for use by trained professionals and make use of the fact that the visible luminescence spectra from dental plaque (and/or caries) and non-decayed regions of a tooth are substantially different. Some dental plaque detection apparatuses are configured for use by consumers (most of whom are, typically, not trained dental professionals) in their own homes in helping consumers achieve good oral hygiene.

For example, one known type of dental plaque apparatus utilizes irradiated light to illuminate tooth material and gums to identify areas infected by biofilms and areas of dental plaque. This type of plaque detection apparatus may utilize a monochromatic excitation light and may be configured to detect fluorescent light in 2 bands 440-470 nm (e.g., blue light) and 560-640 nm (e.g., red light); the intensities are subtracted to reveal the dental plaque and/or caries regions.

While the aforementioned dental plaque apparatus are suitable for their intended use, they exhibit one or more shortcomings. Specifically, it is known that each area of the eye absorbs different wavelengths of light and, if too much light is absorbed by the eye, the eye may be damaged. As can be appreciated, to avoid possible eye injury, it is imperative that a user not switch on the plaque detection apparatus until the plaque detection apparatus is appropriately placed inside the mouth. The aforementioned devices, however, are not configured to automatically detect when the plaque detection apparatus are placed inside the mouth. As a result thereof, potentially harmful radiation that could damage the eyes, or cause uncomfortable glare if exposed to the eyes, may result if proper handling precautions are not followed, e.g., consumer misuse. Furthermore, this technique is especially suitable to detect old plaque; a distinction between teeth fluorescence and young (1 day old) plaque fluorescence is not made

### SUMMARY

The present disclosure describes a method of probing a dental surface by recording the outflow properties of a fluid medium through a probe tip. The properties of the fluid outflowing from the probe tip can for example be measured by recording the pressure of the fluid medium as a function of time. The release properties of bubbles from the tip-surface region can characterize the dental surface and/or the viscoelastic properties of dental material present at the probe tip. The bubbles may also improve the plaque removal rate of the tooth brush.

The novel features of the embodiments of the present disclosure are characterized at a minimum in that:

(a) a fluid medium is brought in contact with a surface at a probe tip, generating an interaction zone between the tip and the surface; and

(b) the shape and/or dynamics of the medium in the interaction zone depend on the properties of the surface and/or on materials derived from the surface; and

(c) the pressure and/or shape and/or dynamics of the of medium in the interaction zone are detected.

A determination is made by a controller as to whether a level of plaque is detected at a particular dental surface of a tooth that exceeds a predetermined maximum acceptable or permissible level of plaque.

If a negative detection is made, a signal is transmitted to the user of the electric toothbrush having an integrated stream probe plaque detection system to advance the brush to an adjacent tooth or other teeth.

Alternatively, if a positive detection is made, a signal is transmitted to the user of the electric toothbrush having an integrated stream probe plaque detection system to continue brushing the particular tooth.

Accordingly, an aspect of the present disclosure includes an apparatus for detecting the presence of a substance on a surface. The apparatus includes a proximal pump (e.g. syringe) portion and at least one distal probe portion configured to be immersed in a first fluid. The at least one proximal pump portion and the at least one distal probe portion are in fluid communication with one another. The distal probe portion defines a distal tip having an open port to enable the passage of a second fluid therethrough. The apparatus is configured such that passage of the second fluid through the distal tip enables detection of a substance that may be present on the surface based on measurement of a signal correlating to, in proximity to the surface, one or more bubbles generated by the second fluid in the first fluid.

In one aspect, the signal is an optical signal correlating to the one or more bubbles. When the surface is hydrophobic, the optical signal may detect the location of one or more bubbles in proximity to the surface as indicative of the presence of a hydrophilic substance in proximity to the surface. In one aspect, the hydrophilic substance is plaque. In another aspect, the surface is hydrophobic and the optical signal may detect the location of one or more bubbles in proximity to the surface as indicative of the presence of the hydrophobic surface. A substance corresponding to the material forming the surface may be enamel.

In yet another aspect, the second fluid is a gas and the signal correlating to one or more bubbles in proximity to the surface is a pressure signal correlating to the one or more bubbles, and the apparatus further includes at least one pressure sensor configured and disposed to detect the pressure signal. The pressure signal may correlate to the distance of the one or more bubbles from the surface. The distance may be indicative of the presence of a hydrophilic substance in proximity to the surface. The hydrophilic substance may be plaque.

In still another aspect, the distance may be indicative of the presence of a hydrophobic substance in proximity to the surface. The hydrophobic substance may be enamel.

In another aspect, the at least one proximal pump portion includes the at least one pressure sensor. Additionally, the at least one proximal pump portion and the at least one distal probe portion may each define internal volumes summing to a total volume of the detection apparatus such that the detection apparatus forms an acoustical low pass filter.

In one aspect, the apparatus may further include at least one pressure sensing portion disposed between the at least one proximal pump portion and the at least one distal probe portion wherein the at least one pressure sensor is disposed in fluid communication with the at least one pressure sensing portion to detect the pressure signal. The at least one proximal pump portion, the at least one pressure sensing portion and the at least one distal probe portion may each define internal volumes summing to a total volume of the detection apparatus such that the detection apparatus forms an acoustical low pass filter.

In another aspect, the proximal pump portion may include a moveable plunger disposed therewithin and configured and disposed such that the moveable plunger is reciprocally moveable away from a proximal end of the proximal pump portion towards a distal end of the proximal pump portion. The movement of the plunger induces thereby a change in pressure in the distal probe portion. The apparatus may further include a controller. The controller may process pressure readings sensed by the pressure sensor and determine whether the pressure readings are indicative of a level of a substance present on the surface that exceeds for the surface a predetermined maximum permissible level of the substance. The substance may be dental plaque.

In yet another aspect of the apparatus, the signal represents strain of the at least one probe portion. The detection apparatus may further include at least one strain gauge configured and disposed on the at least one distal probe portion to enable the at least one strain gauge to detect and measure the signal representing strain of the at least one probe portion.

Yet another aspect of the present disclosure includes a method of detecting the presence of a substance on a surface that includes, via a stream probe tubular member defining an interior channel that includes a distal probe tip enabling the passage of a fluid medium therethrough, disposing the probe tip in proximity to a surface and such that the stream probe is immersed in a first fluid medium, causing a second fluid medium to flow through the interior channel and the distal probe tip and causing the second fluid medium to touch the surface in an interaction zone occurring in the first fluid medium, and probing the properties of the interaction zone via outflow of the second fluid medium from the surface.

In another aspect, the probing of the properties of the interaction zone may include measuring a property of the second fluid medium in the interaction zone. The measuring of a property of the second fluid medium may include measuring one of the shape, or the pressure, or the dynamics of the second fluid medium in the interaction zone.

In another aspect, the probing of the properties of the interaction zone may includes measuring a property of the surface in the interaction zone. The measuring of a property of the surface may include measuring one of the viscoelastic properties or of the surface tension of the surface in the interaction zone.

### BRIEF DESCRIPTION OF THE DRAWINGS

The aspects of the present disclosure may be better understood with reference to the following figures. The components in the figures are not necessarily to scale, emphasis instead being placed upon clearly illustrating the principles of the disclosure. Moreover, in the figures, like reference numerals designate corresponding parts throughout the several views.

In the figures:

FIG. 1 illustrates the general principle of stream probe impacting a dental surface:

FIG. 2 illustrates the effect of surface tension on a hydrophobic surface and on a hydrophilic surface for a stream probe impacting a dental surface;

FIG. 3 illustrates left and right photographs of air bubbles from a needle in water touching a plaque surface on the left and an enamel surface on the right;

FIG. 4A illustrates one embodiment of the present disclosure of a stream probe having a pump portion supplying a continuous stream of gas via a tube to a probe tip while measuring the internal tube pressure;

FIG. 4B illustrates another embodiment of the stream probe of FIG. 4A having a pump portion supplying a continuous stream of gas via a tube to a probe tip while measuring the internal pump pressure;

FIG. 5 illustrates a sample pressure measurement of the syringe of FIG. 4 as a function of time:

FIG. 6 illustrates a sample pressure signal amplitude as a function of distance of the probe tip of FIG. 4 to various dental surfaces;

FIG. 7 illustrates on the left one embodiment of a stream probe having a blockage from dental surface material such as dental plaque while on the right illustrates one embodiment of an unblocked stream probe;

FIG. 8 illustrates on the left a sample pressure measurement versus time for the unblocked stream probe of FIG. 7 and on the right illustrates a sample pressure measurement versus time for the blocked stream probe of FIG. 7;

FIG. 9 illustrates a pressure signal versus time for a stream probe having a Teflon tip;

FIG. 10 illustrates a stream probe system incorporated into a dental apparatus such as an electric toothbrush;

FIG. 11 illustrates a view of the brush of the dental apparatus taken along line 11-11 of FIG. 10 having a stream probe tip at a position within the bristles of the brush;

FIG. 12 illustrates an alternate embodiment of the view of the brush of FIG. 11 wherein the stream probe tip extends distally from the bristles of the brush. More particularly,

FIG. 13 illustrates an alternate embodiment of the brush of FIG. 10 that includes multiple stream probes on the brush that includes the base of the brush;

FIG. 14 illustrates another view of the brush of FIG. 13;

FIG. 15 illustrates still another view of the brush of FIG. 13;

FIG. 16 illustrates another alternate embodiment of the brush of FIG. 10 that includes multiple stream probes on the brush that includes the base of the brush;

FIG. 17 illustrates another view of the brush of FIG. 16;

FIG. 18 illustrates still another view of the brush of FIG. 13;

FIG. 19 illustrates a stream probe operating apparatus that includes a first stream probe;

FIG. 20 illustrates another stream probe operating apparatus that includes a second stream probe; and

FIG. 21 illustrates a motor that is operably connected to a common shaft that operates the stream probe operating apparatuses of FIGS. 19 and 20.

### DETAILED DESCRIPTION

The present disclosure describes various embodiments of systems, devices, and methods related to assisting users to clean their teeth, in particular by informing users if they are indeed removing plaque from their teeth and if they have fully removed the plaque, providing both reassurance and coaching them into good habits. In one embodiment, the information is provided in real time during brushing, as otherwise consumer acceptance is likely to be low. For example, it is useful if a toothbrush gives the user a signal when the position at which they are brushing is clean, so they can move to the next tooth. This may reduce their brushing time, but will also lead to a better, more conscious brushing routine.

A particular goal of utilization of the embodiments of the present disclosure is to be able to detect plaque within a vibrating brush system surrounded with toothpaste foam, e.g., a Philips Sonicare™ toothbrush (manufactured by Koninklijke Philips Electronics, N.V.). The detection system should provide contrast between a surface with the thicker, removable plaque layers, and a more clean pellicle/calculus/thin plaque/tooth surface.

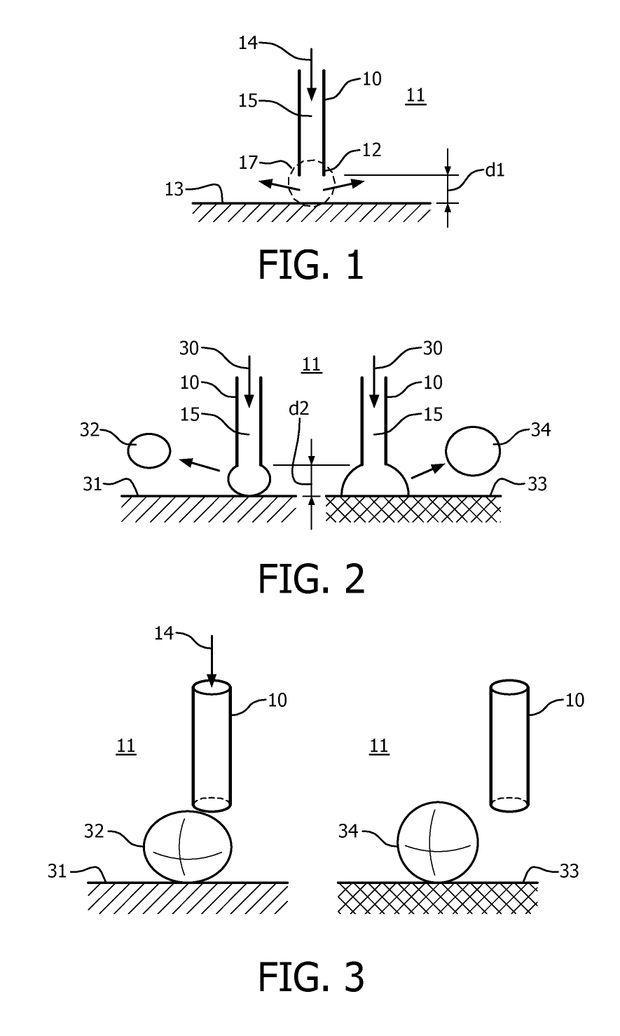

FIG. 1 illustrates a method of detecting the presence of a substance on a surface, e.g., a substance such as dental plaque on a surface such as tooth enamel, using a stream probe 10 according to one embodiment of the present disclosure. The stream probe 10, exemplarily illustrated as a cylindrical tube member, defines an interior channel 15 and a distal probe tip 12. The interior channel 15 contains a fluid medium 14, e.g. a gas. The probe tip 12 is placed in the proximity of a surface 13, e.g. a dental surface. The probe 10 is immersed in a fluid medium 11, e.g. an aqueous solution such as a dental cleaning solution. Probe fluid medium 14 flows through the probe channel 15 and touches surface 13 in interaction zone 17. The properties of the interaction zone 17 are probed via the outflow of probe medium 14.

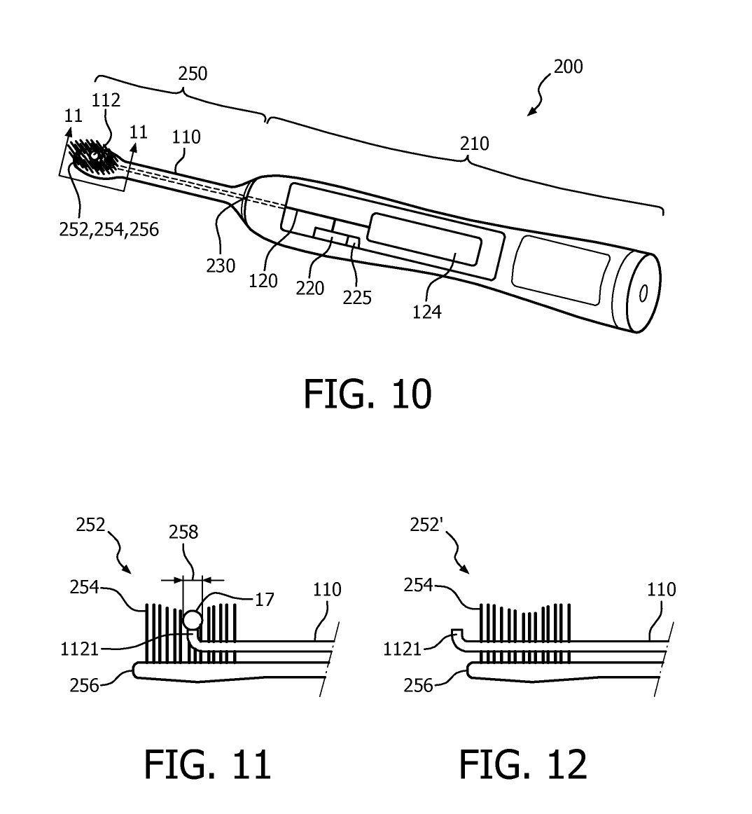

As described in more detail below with respect to FIG. 10, an electric toothbrush having an integrated stream probe plaque detection system is configured such that fluid medium 14 is brought in contact with surface 13, e.g. a dental surface, at probe tip 12, generating interaction zone 17 between distal tip 12 and surface 13.

The shape and/or dynamics of the medium 14 in the interaction zone 17 depend on the properties of the surface 13 and/or on materials derived from the surface 13, the pressure and/or shape and/or dynamics of the of medium 14 in the interaction zone 17 are detected and a determination is made by a controller as to whether a predetermined maximum acceptable level of plaque is detected at the particular dental surface 13, as described in more detail below with respect to FIG. 10.

More particularly, when medium 14 is a gas 30 then a gas meniscus will appear at the tip 12 and will become in contact with surface 13. The shape and dynamics of the gas at the tip will depend on the properties of the probe tip 12 (e.g. tip material, surface energy, shape, diameter, roughness), properties of solution 11 (e.g. materials composition), properties of medium 14 (e.g. pressure, flow speed), and properties of surface 13 (e.g. viscoelastic properties, surface tension) and/or on materials derived from the surface 13 (viscoelastic properties, adherence to surface, texture etc.).

FIG. 2 illustrates the influence of surface tension. In the case of a surface with a high surface energy, e.g. a hydrophilic surface 31 such as the surface of plaque as illustrated in the left photograph, the gas 30 will not easily displace the aqueous medium 11 from the surface 31.

In the case of a surface with a low surface energy, e.g. a hydrophobic surface 33 such as the enamel surface of a tooth as illustrated in the right photograph, the gas 30 more easily displaces the aqueous medium 11 from the surface 33. The properties (shape, pressure, release rate, etc) of bubbles 32 and 34 depend on the surface tension of the dental surface 31 or 33. That is, the stream probe 110 is configured such that passage of the second fluid such as the gas 30 through the distal tip 112 enables detection of a substance that may be present on the surface 31 or 33 based on measurement of a signal correlating to, in proximity to the surface 31 or 33, one or more bubbles 32 or 34 generated by the second fluid such as the gas 30 in the first fluid such as the aqueous medium 11.

FIG. 3 illustrates photographs of such types of air bubbles 32 and 34 from stream probe 10 under aqueous solution 11, e.g., water. As illustrated in the left photograph, an air bubble 32 does not stick on a wet plaque layer 31, while, as illustrated in the right photograph, air bubble 34 does stick on enamel surface 33, showing that the plaque layer 31 is more hydrophilic as compared to enamel surface 33.

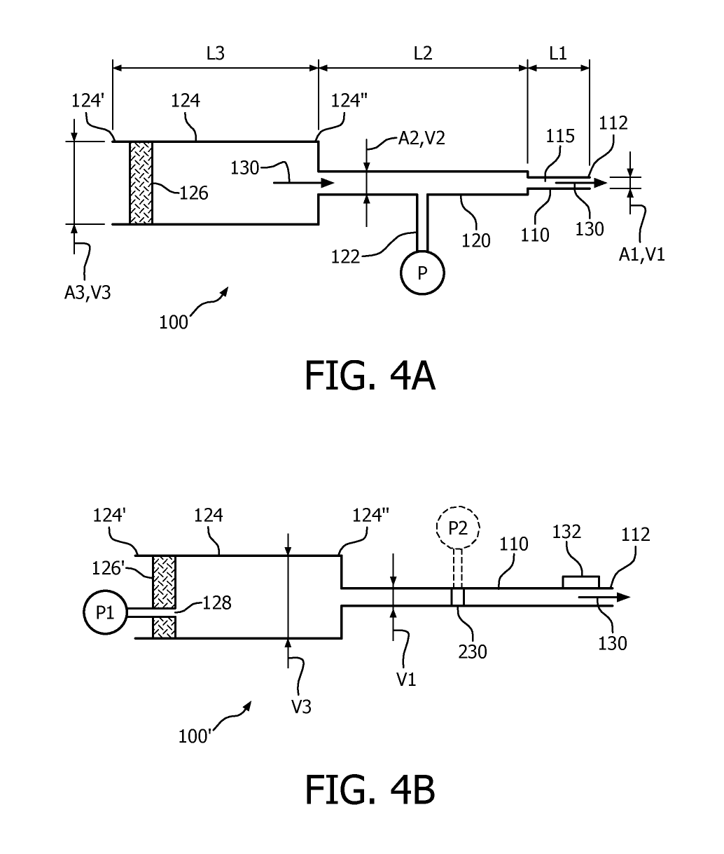

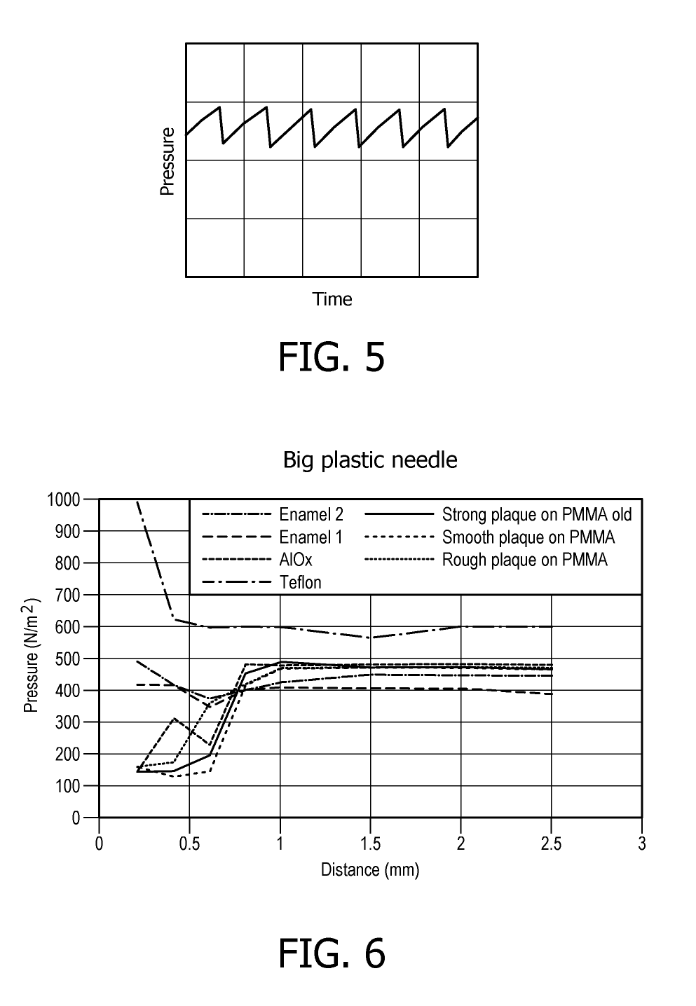

FIG. 4A, 4B and FIG. 5 illustrate a detection apparatus for detecting the presence of a substance on a surface according to one embodiment of the present disclosure, wherein the detection apparatus is exemplified by a stream probe that includes a pressure sensor to demonstrate the principle of plaque detection by pressure sensing and measurement. More particularly, in FIG. 4A, a stream probe 100 includes a proximal pump portion 124 such as a tubular syringe portion as shown, a central pressure sensing portion 120, exemplarily having a tubular configuration as shown, and a distal probe portion 110, also exemplarily having a tubular configuration as shown, defining a distal probe tip 112. The distal tubular probe portion 110 defines a first length L1 and a first cross-sectional area A1, the central pressure sensing tubular portion 120 defines a second length L2 and a second cross-sectional area A2, while the proximal tubular syringe portion 124 defines a third length L3 and a third cross-sectional area A3. The proximal tubular syringe portion 124 includes a reciprocally movable plunger 126 initially disposed in the vicinity of proximal end 124′. A continuous fluid steam 130 of air is supplied by the plunger 126 through the central pressure sensing portion tubular portion 120 to the probe tip 112. when the plunger moves longitudinally along the length L3 at a constant velocity and away from the proximal end 124′. When the fluid stream 130 is a gas, a continuous stream 130 of gas is supplied through the plunger 126 (such as via an aperture 128 in the plunger 126 (see plunger 126′ in FIG. 4B) or from a branch connection 122 connecting to the central pressure sensing tubular portion 120 to the probe tip 112. As the plunger 126 moves along the length L3 towards distal end 124″ of the proximal tubular syringe portion 124, the pressure inside the central pressure sensing tubular portion 120 is measured using pressure meter P that is in fluid communication with the central pressure sensing tubular portion 120 and the distal tubular probe portion 110 via the branch connection 122. When the plunger 126 moves the pressure at pressure meter P versus time characterizes the interaction of the gas meniscus at the tip 112 of the probe 110 with the surface (see FIG. 1, surface 13, and FIGS. 2 and 3, surfaces 31 and 33). For the bubble method, the pressure difference is generally constant, which means that the bubble size varies and so the bubble rate varies with constant plunger velocity, because the volume in the system changes.

FIG. 5 illustrates an example of a pressure signal (measured in Newtons/sq. meter, N/m²) as a function of time (1 division corresponds with a second) utilizing the stream probe 100 of FIG. 4A. The regular variation of the signal is caused by the regular release of gas bubbles at the probe tip 112.

The sensitivity of the pressure readings can be increased by carefully choosing the dimensions of the components. The total volume V1 (equal to A1×L1) plus volume V2 (equal to A2×L2) plus volume V3 (equal to A3×L3) from both the tube 120 and the syringe 124 together with the probe 110, form an acoustical low-pass filter. In the exemplary stream probe 100 of FIG. 4A, the cross-sectional area A3 is greater than the cross-sectional area A2 which in turn is greater than the cross-sectional area A1. The gas flow resistance in the system should be designed small enough to have a good system response time. When bubble-induced pressure differences are recorded, then the ratio between bubble volume and total system volume should be large enough to have a sufficient pressure difference signal due to air bubble release at the probe tip 112. Also the thermo-viscous losses of the pressure wave interacting with the walls of tube 120 as well as the probe 110 must be taken into account, as they can lead to a loss of signal.

In the stream probe 100 illustrated in FIG. 4A, the three volumes differ from one another as an example. However, the three volumes could be equal to one another or the pump volume could be less than the probe volume.

FIG. 4B illustrates an alternate embodiment of a stream probe according to the present disclosure. More particularly, in stream probe 100′, the central pressure sensing portion 120 of stream probe 100 in FIG. 4A is omitted and stream probe 100′ includes only proximal pump portion 124 and distal probe portion 110. A pressure sensor P1 is now exemplarily positioned at plunger 126′ to sense pressure in the proximal pump portion 124 via an aperture 128 in the plunger 126′. Alternatively, a pressure sensor P2 may be positioned in the distal probe portion 110 at a mechanical connection 230.

In a similar manner as described with respect to stream probe 100 in FIG. 4A, volume V3 of the proximal pump portion 124 may be greater than volume V1 of the distal probe portion 110 in stream probe 100′ in FIG. 4B, as illustrated. Alternatively, the two volumes may be equal to one another or volume V3 may be less than volume V1.

Alternatively, a strain gauge 132 may be disposed on the external surface of the distal probe 110. The strain gauge 132 may also be disposed on the external surface of the proximal pump portion 124 (not shown). The strain readings sensed by strain gauge 132 may be read directly or converted to pressure readings as a function of time to yield a readout similar to FIG. 5 as an alternative method to determine the release of gas bubbles at the probe tip 112.

FIG. 6 shows pressure amplitude data as a function of the distance d1 or d2 between probe tip 112 and surface 13 in FIG. 1 or surfaces 31 and 33 in FIG. 2, measured for different surfaces. A plastic needle with 0.42 mm inner diameter was used. Clear differences are visible at distances up to 0.6 mm, where the most hydrophobic surface (Teflon) gives the largest pressure signal, while the most hydrophilic surface (plaque) gives the lowest signal.

FIGS. 1-6 have described a first method of detecting the presence of a substance on a surface, which includes the measurement of bubble release from a tip (by pressure and/or pressure variations and/or bubble size and/or bubble release rate) as a method of detecting, for example, dental plaque at the probe tip 112. As described above with respect to FIGS. 1 and 2 and 6, the probe tip 112 is positioned at a distance d1 or d2 away from the surface such as surface 13 in FIG. 1 or surfaces 31 and 33 in FIG. 2.

It should be noted that although the method of bubble generation and detection has been described with respect to the second fluid being a gas such as air, the method may also be effective when the second fluid is a liquid, wherein water droplets instead of gas bubbles are created.

Additionally, the method may be effected with constant pressure and measurement of the variable outflow.

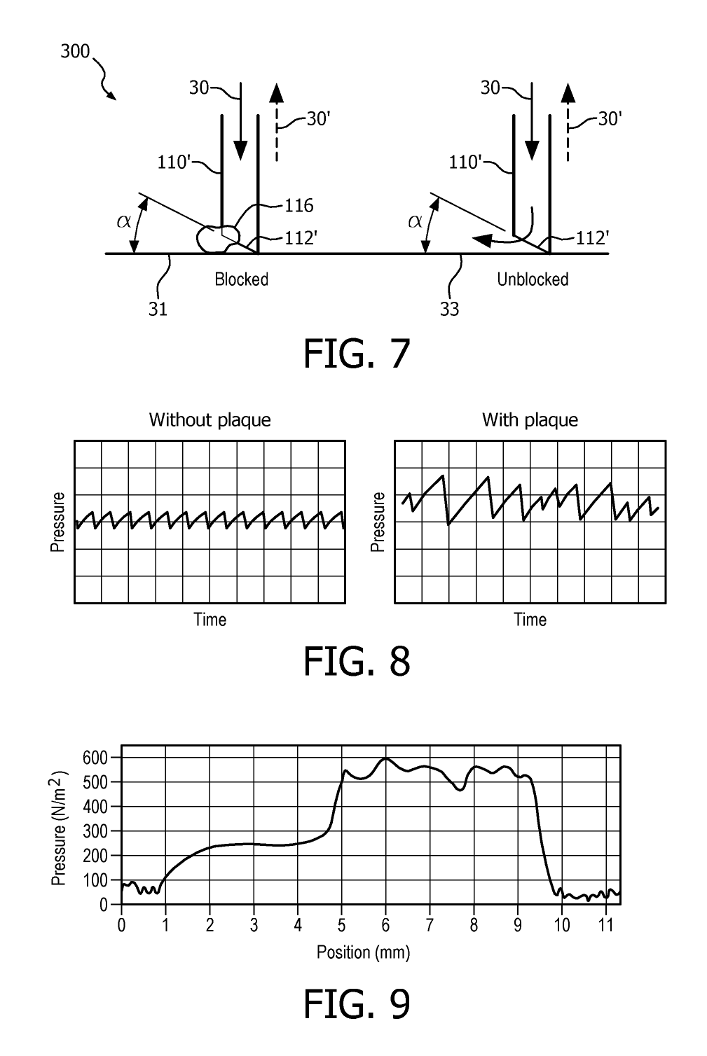

In a second method of detecting the presence of a substance on a surface according to the embodiments of the present disclosure, FIG. 7 illustrates the influence of blocking of the probe tip 112 of the probe 110 of FIG. 4. The probe 110′ illustrated in FIG. 7 differs from probe 110 in FIGS. 4 and 6 in that the probe 110′ includes a chamfered or beveled distal tip 112′ having an open port that is chamfered at an angle α with respect to the horizontal surface 310 such that passage of the second fluid through the distal tip 112′ is enabled when the distal tip 112′ touches the surface 310. The angle α of the chamfer of the open port is such that passage of the second fluid through the distal tip 112′ is at least partially obstructed when the distal tip 112′ touches the surface 31 or 33 and a substance 116, such as viscoelastic material 116, at least partially obstructs the passage of fluid through the open port of the distal tip 112′. At least two probes 110′ are generally required to detect obstruction of the passage of fluid.

Alternatively, the probe tips 112 of FIGS. 1, 2, 4A or 4B are utilized without chamfered or beveled ends and simply held at an angle (such as angle α) to the surface 31 or 33.

As illustrated on the left portion of FIG. 7, when the probe tip 112′ becomes blocked by viscoelastic material 116 from the dental surface 31, then the gas 30 will flow less easily out of the tip 112′, as compared to when probe tip 112′ is not blocked and is without dental material at the tip 112′ or at dental surface 33, as illustrated in the right portion of FIG. 7.

FIG. 8 illustrates pressure signals of a probe tip, e.g., a metal needle with a bevel, moving on enamel without plaque, as illustrated on the left, and on a sample with a plaque layer, as illustrated on the right. The increase in pressure seen in the right portion, attributed to obstruction of the needle opening by the plaque, can be sensed to detect if plaque is present.

FIG. 9 illustrates pressure signals of an airflow from a Teflon tip moving over water, PMMA (polymethyl methylacrylate), PMMA with plaque, and water. The tip moves (from left to right) over water, PMMA, PMMA with plaque, and again over water. See for example FIG. 3 for illustration of the tip motion.

When reference is made to pressure differences herein, consideration of the following should be taken into account. In FIG. 8, the fluid stream 30 is obstructed when the pressure increases on the left panel. So the parameter of interest is the average pressure or average or momentary peak pressure.

In contrast, FIG. 9 illustrates identical signals for a smaller probe tip, in which case a much smoother signal is obtained.

In preliminary experiments according to FIG. 2, we have observed the following:

Dental plaque (in wet state) is more hydrophilic than clean enamel, as shown in FIG. 3.

The release of air bubbles from the tip is measurable by pressure variations. A syringe with constant displacement velocity gives a sawtooth-like signal of pressure as a function of time. This is shown in the oscilloscope photograph in FIG. 5.

In case of close approach between tip and surface, the amplitude of the sawtooth signal is smaller when the probed surface is hydrophilic than when the surface is hydrophobic. So, smaller air bubbles are released on the hydrophilic surface. This is also demonstrated by the measurements in FIG. 6, where the pressure signal amplitude as a function of distance d1 or d2 from the tip to the surface (see FIGS. 1 and 2) is given for different surfaces.

In preliminary experiments according to FIG. 7, we have observed the following:

An unblocked tip gives a regular release of air bubbles and a sawtooth-like pattern of pressure versus time, when a syringe is used with a constant displacement velocity. See the left panel of FIG. 8.

In an experiment with a metal tip moving through plaque material, an increase of pressure and an irregular sawtooth-like pattern of pressure versus time was observed, due to blocking of the tip by plaque material and opening of the tip by the air. See the right panel of FIG. 8.

In an experiment with a Teflon tip, clear signal differences were seen for different materials at the tip opening (from left to right: tip in water, tip above PMMA, above PMMA with plaque, and again tip in water).

These preliminary experiments indicate that the measurement of bubble release from a tip (by pressure and/or pressure variations and/or bubble size and/or bubble release rate) may become a suitable method to detect dental plaque at the tip. Experimental work will continue, because the results are still incomplete and not yet final.

Accordingly, in view of the foregoing, at a minimum, the novel features of the embodiments of the present disclosure are characterized in that:

(a) fluid medium 14 is brought in contact with surface 13 at probe tip 12, generating interaction zone 17 between tip 12 and surface 13 (see FIG. 1); and (b) the shape and/or dynamics of the medium 14 in the interaction zone 17 depend on the properties of the surface 13 and/or on materials derived from the surface 13; and (c) the pressure and/or shape and/or dynamics of the of medium 14 in the interaction zone 17 are detected.

In view of the foregoing description of the two differing methods of detecting the presence of a substance on a surface, the proximal pump portion 124 in FIGS. 4A and 4B effectively functions as a syringe. During injection of the plunger 126 or 126′ distally, gas or air flow or liquid flow at the tip 112 in FIGS. 4A and 4B, or tip 112′ in FIG. 7, can be pushed outwardly away from the tip (when the plunger is pushed).

(b) During retraction or reverse travel of the plunger 126 or 126′, gas or air flow or liquid flow can be suctioned inwardly at the tip 112 or 112′ and in towards the probe tube 110 or 110′. In one embodiment, the plunger 126 or 126′ is operated automatically together with the vibration of the bristles of an electric toothbrush or where the bristles are not vibrating (e.g. using the same principle in a dental floss device).

Accordingly, the syringe or pump 124 can be used for the stream method in which flow of gas or air is injected away from the tip 112 and towards the enamel to generate bubbles 32 or 34. (a) The bubbles and locations are detected optically and depending on whether the surface is hydrophilic such as plaque or hydrophobic such as enamel, the location of the bubble will determine whether there is plaque present. The tip 112 is located at a particular distance d2 (see FIG. 2) away from the enamel regardless of whether plaque is present or not.

Alternatively, pressure sensing can also be used for the bubble method. Referring to FIG. 2, the same pump portion 124 functioning as a syringe can be used for the pressure sensing method as follows. (a) Liquid is injected towards the enamel surface 31 or 33. The probe tip 112 is initially located at a particular dimension away from the enamel surface such as d2 in FIG. 2. The pressure signal is monitored as illustrated and described above in FIGS. 5 and 6. Bubble release measurements are performed by pressure and/or pressure variations as described above.

In the second method of detecting the presence of a substance on a surface according to the embodiments of the present disclosure, as illustrated in FIG. 7, the passage of the second fluid such as gas 30 through the distal tip enables detection of substance 116 that may be present on the surface 31 based on measurement of a signal, correlating to a substance at least partially obstructing the passage of fluid through the open port of the distal tip 112′.

Since at least two probes 110′ are utilized, FIG. 7 illustrates a system 300 for detecting the presence of a substance on a surface. In one embodiment, the probes 110′ are in contact with the surface 31 or 33 as described above. If there is no plaque at the surface, 33, i.e., flow is unblocked, then the pressure signal is as shown in FIG. 8, left panel. If there is plaque at the surface, e.g., viscoelastic material 116, then the pressure signal is as shown in FIG. 8, right panel.

For practical applications, it is contemplated that the probes 110′ have a very small diameter, e.g., less than 0.5 millimeters, such that by their spring function, the probe tips 112′ will make contact with the tooth surface 33. So when reaching the plaque the tube is pressed into this layer of plaque. The pressure signals illustrated in FIG. 8 were obtained with a single probe in contact.

In an alternate embodiment of the second method of detecting the presence of a substance on a surface, fluid is suctioned away from the enamel surface by reverse travel of the plunger 126 or 126′ proximally towards the proximal end 124′ of the proximal pump portion 124′ in FIGS. 4A and 4B. Fluid or gas inflow 30 now becomes fluid or gas outflow 30′ as illustrated by the dotted arrows. If there is plaque 116 present, the plaque either is large enough to block the aperture at the probe tip or is small enough to be suctioned inside the probe channel. The pressure signal becomes an inverted version of FIG. 8. Lower pressure will be obtained in the presence of plaque.

As defined herein, regardless of the direction of flow of the second fluid through the probe tip, obstruction can mean either a direct obstruction by a substance at least partially, including entirely, blocking the tip itself or obstruction can mean indirectly by the presence of a substance in the vicinity of the probe tip tip opening thereby perturbing the flow field of the second fluid.

In addition to performing the first and second methods by maintaining a constant velocity of the plunger, the methods may be performed by maintaining constant pressure in the proximal pump portion and measuring the variable outflow of the second fluid from the probe tip

Additionally, for either the first method of bubble detection or the second method of obstruction, although the flow of the second fluid is generally laminar, turbulent flow of the second fluid is also within the scope of present disclosure.

FIG. 10 illustrates a detection apparatus for detecting the presence of a substance on a surface according to one embodiment of the present disclosure wherein the detection apparatus is exemplified by the integration of the stream probe into a dental apparatus such as a tooth brush, forming thereby a detection apparatus for detecting the presence of a substance on a surface.

Traditionally an electric toothbrush system, such as the Philips Sonicare™ toothbrush mentioned above, comprises a body component and a brush component. Generally, the electronic components (motor, user interface UI, display, battery etc.) are housed in the body, whilst the brush component does not comprise electronic components. For this reason, the brush component is easily exchangeable and replaceable at a reasonable cost.

In one embodiment, detection apparatus 200, e.g., an electric toothbrush, is configured with a proximal body portion 210 and a distal oral insertion portion 250. The distal oral insertion portion 250 includes a vibrating brush 252 with brush base 256 and bristles 254 and an air stream probe such as air stream probe 100 described above with respect to FIG. 4A or 100′ with respect to FIG. 4B. In conjunction with FIGS. 4A and 4B, the detection apparatus 200 is configured such that active (electronic) components are incorporated within, or disposed externally on, the proximal body portion 210, whilst the passive components such as probe 110, are incorporated within, or disposed externally on, distal oral insertion portion 250. More particularly, probe tip 112 of probe 110 is incorporated close to or within the bristles 254, while the central pressure sensing tubular portion 120 and the proximal tubular syringe portion 124 are incorporated within, or disposed externally on, proximal body portion 210.

In one embodiment, the distal oral insertion portion 250, including the brush 252 that includes brush base 256 and bristles 254, is exchangeable or replaceable. Contact to the body with the active parts is provided by a mechanical connection 230, where an air stream is generated and the pressure is sensed, such as at the location of pressure P2 in FIG. 4B. Based on the pressure sensor signal, it is concluded if plaque is present at the area of the probe tip 112.

In one embodiment, the active components comprise the pressure sensor P as described above. In conjunction with FIG. 1, the sensor P is used to sense the shape and/or dynamics of the medium 14 in the interaction zone 17. Such a sensor has the advantage that it is robust and simple to use. The sensor P is in electrical communication with detection electronics 220 that include a controller 225 that is in electrical communication therewith.

In an alternate embodiment, the active component may comprise an optical, electrical or acoustic sensor like for example a microphone, in order to sense the shape and/or dynamics of the medium 14 in the interaction zone 17.

The controller 225 can be a processor, microcontroller, a system on chip (SOC), field programmable gate array (FPGA), etc. Collectively the one or more components, which can include a processor, microcontroller, SOC, and/or FPGA, for performing the various functions and operations described herein are part of a controller, as recited, for example, in the claims. The controller 225 can be provided as a single integrated circuit (IC) chip which can be mounted on a single printed circuit board (PCB). Alternatively, the various circuit components of the controller, including, for example, the processor, microcontroller, etc. are provided as one or more integrated circuit chips. That is, the various circuit components are located on one or more integrated circuit chips.

Furthermore, the active components enable a method of generating an air or fluid stream, where an air stream is the preferred embodiment. A combined air with fluid stream is possible as well. The method may comprise an electrical or a mechanical pumping method, whereby the mechanical method may comprise a spring component which is mechanically activated, e.g., wherein plunger 126 in FIG. 4 is mechanically activated. In one embodiment, the method of generating the air stream is an electrical pumping principle, as this combines well with the pressure sensing component described above.

In yet another embodiment, the passive components comprise only a tube with an opening at the end, such as probe 110 and distal tip 112 (see FIG. 10).

In still another embodiment, connection of the active and passive components is realized by a mechanical coupling 230 of the tube to the output of the pressure sensor. Such a coupling is ideally substantially pressure sealed. Pressure values are relatively low (<<1 bar)

In operation, the sensing is carried out in a repetitive manner during the tooth brushing process. In a preferred embodiment, sensing is carried out at a frequency >1 Hz, more preferably >5 Hz and even more preferably >10 Hz. Such a high frequency embodiment facilitates the dynamic and real time measurement of plaque removal as the toothbrush is moved from tooth to tooth, as several measurements may be made on an individual tooth (the dwell time on a given tooth is typically of the order of 1-2 seconds).

In conjunction with FIG. 1, as described above, the shape and/or dynamics of the medium 14 in the interaction zone 17 depend on the properties of the surface 13 and/or on materials derived from the surface 13, the pressure and/or shape and/or dynamics of the of medium 14 in the interaction zone 17 are detected and a determination is made by the controller 225 as to whether a level of plaque exceeding a predetermined maximum permissible level of plaque is detected at the particular dental surface 13.

If a positive detection is made, no progression or advancement signal is transmitted to the user of the electric toothbrush until a predetermined maximum permissible plaque level is achieved at the particular dental surface 13 by continued cleaning at the dental surface 13 of that particular tooth.

Upon reduction of the level of plaque to at or below the maximum permissible plaque level, i.e., a negative detection is made, a progression signal or advancement signal is transmitted to the user to inform the user that it is acceptable to progress to an adjacent tooth or other teeth by moving the vibrating brush and probe tip of the dental apparatus.

Alternatively, if a positive detection is made, a signal is transmitted to the user of the electric toothbrush having an integrated stream probe plaque detection system to continue brushing the particular tooth.

Furthermore, there are several preferred modes of operation of the passive component in the brush.

In a first mode operation, the tube is configured such that the tip of the tube is acoustically uncoupled from the vibration of the brush (which vibrates at about 265 Hz in a Sonicare™ toothbrush). This may be achieved by only weakly coupling the tube to the brush head.

In a further mode operation, the tube is configured such that the tip of the tube is static. This may be achieved by choosing the mechanical properties of the tube (stiffness, mass, length) such that the tip of the probe is at a static node of vibration at the driving frequency. Such a situation may be helped by adding additional weight to the end of the tube close to the opening.

As illustrated in FIG. 11, which is a partial cross-sectional view of distal oral insertion portion 250 in FIG. 10, in a further embodiment, the effect of the motion of bristles of the toothbrush on the sensing function is reduced by incorporating a spacing 258 around the tube where the bristles are removed. More particularly, probe 110 in FIG. 11 illustrates a brush head 252 that includes base 256 and bristles 254 that protrude generally orthogonally from the base 256. Spacing 258 is positioned with removed bristle wires around probe tip 1121. The probe tip 1121 differs from probe tips 112 and 112′ in that probe tip 1121 includes a 90 degree elbow so as to enable fluid flow through the probe 110 towards the surface 31 or 33.

In one embodiment, the spacing 258 should be of the order of the amplitude of the vibration of the bristles 254. In practice, the bristles vibrate with an amplitude of around 1-2 mm. This makes the sensing more robust.

In a further embodiment, as illustrated in FIG. 12, the probe tip 1121 is situated distally beyond the area covered by the bristles 254. This makes it possible to detect plaque which is present beyond the present position of the brush, for example plaque which has been missed by an incomplete brushing action.

As a further detail, ideally the angle of the brush 252 while brushing is 45 degrees with respect to the tooth surface 31 or 33. Ideally the angle of the probe tip 1121 is close to 0 degrees with respect to the tooth surface 31 or 33. At least two probes 110 and correspondingly at least two pressure sensors and two pumps with a tip end 1121 of 45 degrees with respect to the tooth surface 31 or 33, so that always one probe is interfacing optimally the surface 31 or 33.

In still a further embodiment, a plurality of probes are incorporated in the brush. These probes may alternatively be disposed or utilized at least as follows:

(a) positioned at multiple positions around the brush, to sense for (missed) plaque more effectively or

(b) used for differential measurements to determine the degree and effectiveness of the plaque removal.

In one embodiment, the plurality of probes may be realized with a single active sensing component and a multiplicity of passive components, such as tubes, attached to a single pressure sensor. Alternatively, a plurality of active and passive sensing components may be used.

The end of the tube may have many dimensions, as described above. In alternative embodiments, the tip of the tube will be spaced from the surface of the tooth using a mechanical spacer. In some embodiments, the opening may be made at an angle to the tube.

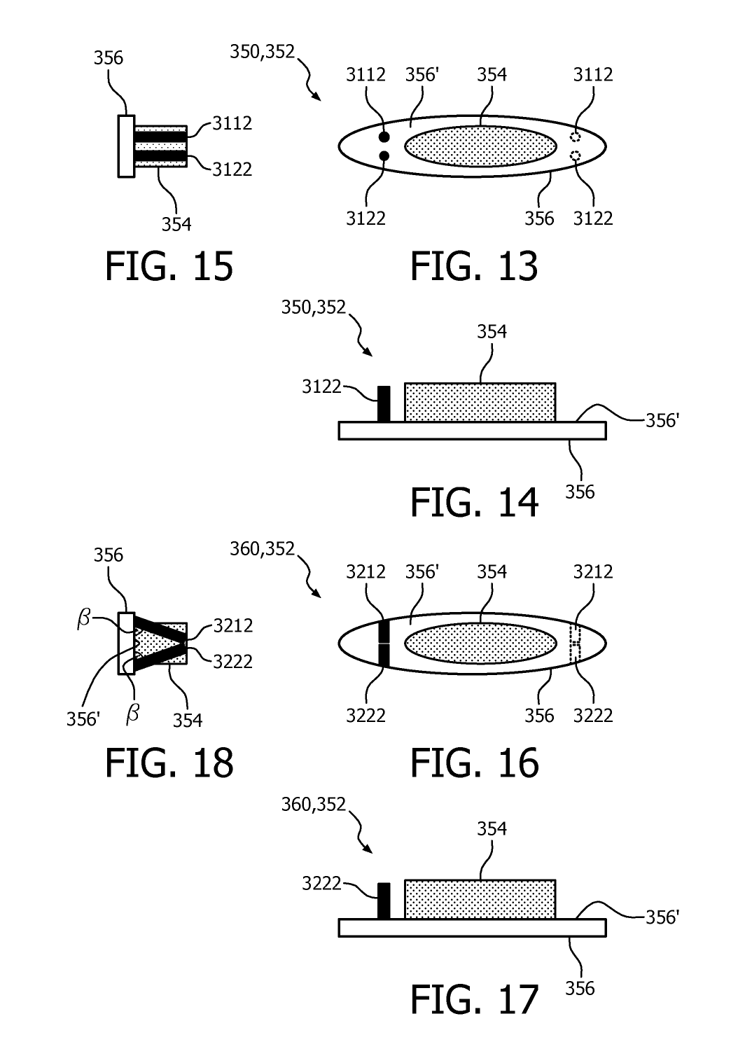

FIGS. 13-21 illustrate examples of the foregoing. More particularly, FIGS. 13-15 illustrate an alternate distal oral insertion portion 350 that includes a brush 352 with bristles 354 mounted on brush base 356, and as illustrated in FIG. 13 as viewed looking towards the brush base 356 and the upper tips of the bristles 354. As best illustrated in FIGS. 14 and 15, extending generally orthogonally from horizontal upper surface 356′ of brush base 356 are distal probe tips 3112 and 3122 which enable multiple fluid flows to be directed towards the surface of interest such as surfaces 31 and 33 in FIGS. 2 and 7. Alternate or additional positions for distal probe tips 3112 and 3122 are illustrated by the dotted lines in the vicinity of the proximal end of the brush base 356. in FIG. 13.

In a similar manner, FIGS. 16-18 illustrate another alternate distal oral insertion portion 360 that includes the brush 352 with 352 with bristles 354 mounted on brush base 356. and as illustrated in FIG. 16 as viewed looking towards the brush base 356 and the upper tips of the bristles 354. As best illustrated in FIG. 18, each extending at an angle β with respect to the horizontal upper surface 356′ of brush base 356 are distal probe tips 3212 and 3222 which enable multiple fluid flows to be directed at angle β towards the surface of interest such as surfaces 31 and 33 in FIGS. 2 and 7. In a similar manner, alternate or additional positions for distal probe tips 3212 and 3222 are illustrated by the dotted lines in the vicinity of the proximal end of the brush base 356. in FIG. 16.

The distal oral insertion portions 350 and 360 illustrated in FIGS. 13-15 and FIGS. 16-18 may be utilized for either: (a) the first method of detecting the presence of a substance on a surface which includes the measurement of bubble release from a tip (by pressure and/or pressure variations and/or bubble size and/or bubble release rate), or (b) for the second method of detecting the presence of a substance on a surface which includes the passage of the second fluid such as a gas through the distal tip based on measurement of a signal, correlating to a substance obstructing the passage of fluid through the open port of the distal tip.

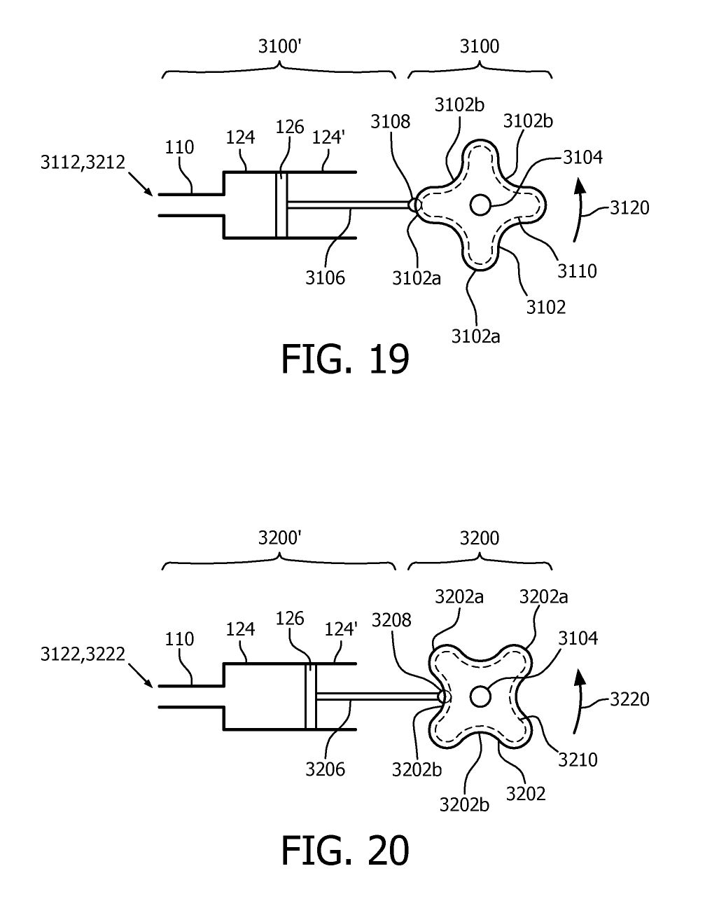

FIGS. 19-21 illustrate exemplary embodiments of multiple stream probes and corresponding proximal pump portions that may be operated by a common rotating shaft and motor. More particularly, FIG. 19 illustrates a first stream probe operating apparatus 3100 that includes first stream probe 3100′. First stream probe 3100′ is identical to the stream probe 100′ described above with respect to FIG. 4B and may include the proximal pump portion 124 and plunger 126 and either the distal probe tip 3112 (see FIGS. 13-15) or the distal probe tip 3212 (see FIGS. 16-18). A rotary to linear motion operating member 3102, which may be a cam mechanism as illustrated, is in operable communication with the plunger 126 via a reciprocating shaft 3106 and a roller mechanism 3108 disposed on the proximal end of the shaft 3106.

The roller mechanism 3108 engages in a channel 3110 defining a path on the periphery of the cam mechanism 3102. The channel 3110 extends along the path to include cam peaks 3102a and cam troughs 3102b. The cam mechanism 3102 is mounted on and rotated by a common shaft 3104, in a direction such as the counterclockwise direction illustrated by arrow 3120. As the cam mechanism 3102 rotates, a reciprocating linear motion is imparted to the shaft 3106 as the roller mechanism 3108 is intermittently pushed by the peaks 3102a or pulled into the troughs 3102b. Thereby, a reciprocating linear motion is imparted to the plunger 126, pressure is generated in the stream probe 3100′, and fluid flow passes through the distal tips 3112 or 3212. Those skilled in the art will understand that the path defined by the channel 3110 may be designed to impart a generally constant velocity to the plunger 126. Alternatively, the path defined by the channel 3110 may be designed to impart a generally constant pressure in the proximal pump portion 124. The plunger 126 is at a position distally away from the proximal end 124′ of the proximal plunger portion 124 since the roller mechanism 3108 is at a peak 3102a.

FIG. 20 illustrates a second stream probe operating apparatus 3200 that includes second stream probe 3200′. Second stream probe 3200′ is also identical to the stream probe 100′ described above with respect to FIG. 4B and may include the proximal pump portion 124 and plunger 126 and either the distal probe tip 3122 (see FIGS. 13-15) or the distal probe tip 3222 (see FIGS. 16-18). Again, a rotary to linear motion operating member 3202, which may be a cam mechanism as illustrated, is in operable communication with the plunger 126 via a reciprocating shaft 3206 and a roller mechanism 3208 disposed on the proximal end of the shaft 3206.

Similarly, the roller mechanism 3208 engages in a channel 3210 defining a path on the periphery of the cam mechanism 3202. The channel 3210 extends along the path to include cam peaks 3202a and cam troughs 3202b. The cam mechanism 3202 is mounted on and rotated by a common shaft 3204, in a direction such as the counterclockwise direction illustrated by arrow 3220. As the cam mechanism 3202 rotates, a reciprocating linear motion is imparted to the shaft 3206 as the roller mechanism 3208 is intermittently pushed by the peaks 3202a or pulled into the troughs 3202b. Thereby, a reciprocating linear motion is also imparted to the plunger 126, pressure is generated in the stream probe 3200′, and fluid flow passes through the distal tips 3122 or 3222. Again, those skilled in the art will understand that the path defined by the channel 3210 may be designed to impart a generally constant velocity to the plunger 126. Again, alternatively, the path defined by the channel 3110 may be designed to impart a generally constant pressure in the proximal pump portion 124. In contrast to first stream probe operating apparatus 3100, the plunger 126 is at a position at the proximal end 124′ of the proximal plunger portion 124 since the roller mechanism 3208 is now at a trough 3202b.

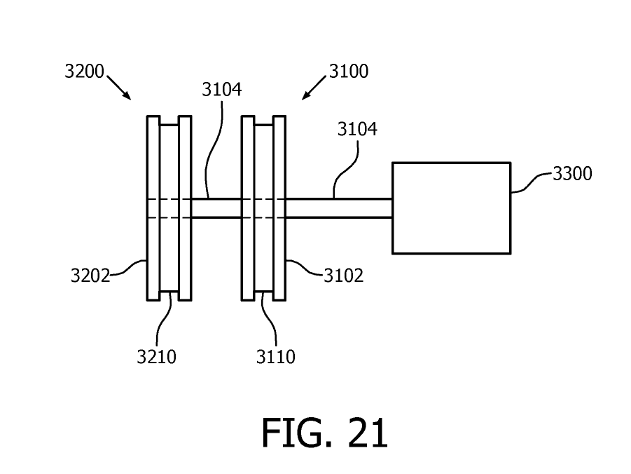

FIG. 21 illustrates a motor 3300 that is operably connected to the common shaft 3104 such that the first rotary to linear motion operating member 3102 of stream probe operating apparatus 3100 is mounted proximally on the common shaft 3104 with respect to the motor 3300 while the second rotary to linear motion operating member 3202 of stream probe operating apparatus 3200 is mounted distally on the common shaft 3104 with respect to the motor 3300. Those skilled in the art will recognize that rotation of the common shaft 3104 by the motor 3300 causes the multiple stream probe operation as described above with respect to FIGS. 19 and 20.

Those skilled in the art will recognize that the stream operating apparatuses 3100 and 3200 described with respect to FIGS. 19-21 are merely examples of apparatuses which may be employed to effect the desired operation.

The supply of air bubbles to a tooth brush may also improve the plaque removal rate of the brushing (At the current time, such experiments have not yet been performed).

One possible mechanism is that (i) air bubbles will stick to spots of clean enamel, (ii) brushing brings a bubble into motion, and thereby also the air/water interface of the bubble, and (iii) when the bubble edge contacts plaque material, the edge will tend to peel the plaque material off the enamel, because the plaque material is very hydrophilic and therefore prefers to stay in the aqueous solution. Another possible mechanism is that the presence of bubbles can improve local mixing and shear forces in the fluid, thereby increasing the plaque removal rate. It should be noted that other embodiments of the methods of detection of a substance on a surface as described herein may include monitoring the first derivative of the signals, AC (alternating current) modulation, and utilization of a sensor for gum detection.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

1. A stream probe apparatus for detecting the presence of a substance on a dental surface, the apparatus comprising:
at least one proximal pump portion; and
at least one distal probe portion configured to be immersed in a first fluid,
the at least one proximal pump portion and the at least one distal probe portion in fluid communication with one another,
the distal probe portion defining a distal tip having an open port to enable the passage of a second fluid therethrough,
the apparatus configured such that passage of the second fluid through the distal tip enables detection of a substance that may be present on the dental surface based on measurement of a signal correlating to, in proximity to the dental surface, one or more bubbles generated by the second fluid in the first fluid.

2. (canceled)

3. The detection apparatus according to claim 1, wherein the dental surface is hydrophobic and wherein the signal detects the location of one or more bubbles in proximity to the surface as indicative of the presence of a hydrophilic substance in proximity to the surface.

4. The detection apparatus according to claim 3, wherein the hydrophilic substance is plaque.

5. The detection apparatus according to claim 1, wherein the dental surface is hydrophobic and wherein the optical signal detects the location of one or more bubbles in proximity to the surface as indicative of the presence of the hydrophobic surface.

6. (canceled)

7. The detection apparatus according to claim 1, wherein the second fluid is a gas and wherein the signal correlating to one or more bubbles in proximity to the surface is a pressure signal correlating to the one or more bubbles, the apparatus further comprising at least one pressure sensor configured and disposed to detect the pressure signal.

8. The detection apparatus according to claim 7, wherein the pressure signal correlates to the distance of the one or more bubbles from the surface.

9. The detection apparatus according to claim 8, wherein the distance is indicative of the presence of a hydrophilic substance in proximity to the surface.

10. The detection apparatus according to claim 9, wherein the hydrophilic substance is plaque.

11. The detection apparatus according to claim 8, wherein the distance is indicative of the presence of a hydrophobic substance in proximity to the surface.

12. (canceled)

13. The detection apparatus according to claim 7, wherein the at least one proximal pump portion includes the at least one pressure sensor.

14. The detection apparatus according to claim 13, wherein the at least one proximal pump portion and the at least one distal probe portion each define internal volumes summing to a total volume of the detection apparatus such that the detection apparatus forms an acoustical low pass filter.

15. (canceled)

16. (canceled)

17. The detection apparatus according to claim 7, wherein the proximal pump portion comprises a moveable plunger disposed therewithin and configured and disposed such that the moveable plunger is reciprocally moveable away from a proximal end of the proximal pump portion towards a distal end of the proximal pump portion, the movement of the plunger inducing thereby a change in pressure in the distal probe portion.

18. The detection apparatus according to claim 17, wherein the apparatus further comprises a controller, the controller processing pressure readings sensed by the pressure sensor and determining whether the pressure readings are indicative of a level of a substance present on the surface that exceeds for the surface a predetermined maximum permissible level of the substance.

19. The detection apparatus according to claim 18 wherein the substance is dental plaque.

20. The detection apparatus according to claim 1, wherein the signal represents strain of the at least one probe portion, the detection apparatus further comprising at least one strain gauge configured and disposed on the at least one distal probe portion to enable the at least one strain gauge to detect and measure the signal representing strain of the at least one probe portion.

21-25. (canceled)
